(19) United States
(12) Patent Application Publication
(10) Pub. No.: US 2011/0015789 A1
(43) Pub. Date: Jan. 20, 2011

(54) WINDOW AND DOOR HARDWARE WITH INTEGRATED WIRELESS SENSORS

(75) Inventor: James R. LaJeunesse, Nashua, NH (US)

Correspondence Address: Vern Maine & Associates, 547 AMHERST STREET, 3RD FLOOR, NASHUA, NH, 03063-4000, US

(73) Assignee: THE BRONZE CRAFT CORPORATION, Nashua, NH (US)

(21) Appl. No.: 12/504,694

(22) Filed: Jul. 17, 2009

(51) Int. Cl. G05D 23/19; G06F 1/26; G06F 17/00; G06F 15/00

(52) U.S. Cl. 700/278; 700/295; 702/188; 700/90

(57) ABSTRACT

A system for the sensing of ambient parameters within an enclosure is provided having: a hardware closure whereby an aperture to the enclosure is secured; at least one sensor disposed within the hardware closure; a wireless transmitter disposed within the hardware, communicating with the at least one sensor; a base station, wirelessly in communication with the transmitter; a processing unit, whereby data collected by the sensor and transmitted by the transmitter to the base station is processed and information relevant to the environment of the enclosure obtained.

### FIELD OF THE INVENTION

The invention relates to window and door hardware, and more particularly, to window and door hardware with integrated electronic sensors.

### BACKGROUND OF THE INVENTION

Energy efficiency is an increasing sought after quality in buildings as energy prices increase and concerns over the environmental impact of energy usage become more acute. As much inefficiency results from thermal transmission at windows and doors, monitors for these areas would allow a user to more accurately direct heating and cooling resources to areas of a building where they are more needed and to alert building managment of open or compromised windows.

Likewise, building security can be compromised by improperly secured windows and doors. Latches left unlocked, unmaintained or weakened, or with missing or broken glazing can allow access by criminals and other elements to secured locations.

What is needed, therefore, are techniques for monitoring the energy and security of buildings and rooms.

### SUMMARY OF THE INVENTION

One embodiment of the present invention provides a system for the sensing of ambient parameters within an enclosure, that system comprising: a hardware closure whereby an aperture to the enclosure is secured; at least one sensor disposed within the hardware closure; a wireless transmitter disposed within the hardware, communicating with the at least one sensor; a base station, wirelessly in communication with the transmitter; a processing unit, whereby data collected by the sensor and transmitted by the transmitter to the base station is processed and information relevant to the environment of the enclosure obtained.

Another embodiment of the present invention provides such a system wherein the information relevant to the environment of the enclosure is related to a user.

A further embodiment of the present invention provides such a system wherein the information relevant to the environment of the enclosure is relayed to an environmental control system.

Yet another embodiment of the present invention provides such a system wherein the environmental control system is selected from the group of environmental control systems consisting of lighting controls, heating controls, air conditioning controls, security systems, humidity control systems and combinations thereof.

A yet further embodiment of the present invention provides such a system wherein the sensor is a pressure sensor disposed between first and second parts of the hardware closure, such that when the hardware closure is latched, the pressure sensor is compressed.

Still another embodiment of the present invention provides such a system wherein the sensor is a photosensor, whereby light intensity entering the aperture is measured.

A still further embodiment of the present invention provides such a system wherein the sensor is a thermal sensor, whereby ambient temperature is measured.

Even another embodiment of the present invention provides such a system wherein the sensor is a thermal sensor, whereby external temperature is measured.

An even further embodiment of the present invention provides such a system wherein the processing unit is a central processor receiving data from a plurality of enclosures.

Yet even another embodiment of the present invention provides such a system wherein the enclosure is a room.

A yet even further embodiment of the present invention provides such a system wherein the aperture is a window.

Still even another embodiment of the present invention provides such a system wherein the aperture is a door.

A still even further embodiment of the present invention provides such a system further comprising a photorechargable power storage device supplying power to the sensor and the transmitter.

One embodiment of the present invention provides a method for monitoring conditions of a room, the method comprising: installing sensors in window and door hardware disposed within a room; coupling the sensors to wireless transmitters disposed proximately to the window and door hardware; linking wirelessly the wireless transmitters to a base station; processing data collected by the sensors with a processor receiving the data collected by the sensors.

Another embodiment of the present invention provides such a method further comprising adjusting environmental controls based on results from the processing.

A further embodiment of the present invention provides such a method wherein the environmental controls comprise of heating/cooling systems.

Still another embodiment of the present invention provides such a method wherein the environmental controls comprise lighting systems.

A still further embodiment of the present invention provides such a method wherein the environment controls comprise premises security systems.

The features and advantages described herein are not all-inclusive and, in particular, many additional features and advantages will be apparent to one of ordinary skill in the art in view of the drawings, specification, and claims. Moreover, it should be noted that the language used in the specification has been principally selected for readability and instructional purposes, and not to limit the scope of the inventive subject matter.

### BRIEF DESCRIPTION OF THE DRAWINGS

FIG. 1 is an end elevation view illustrating a window latch configured in accordance with one embodiment of the present invention.

FIG. 2 is a front elevation view illustrating a window latch configured in accordance with one embodiment of the present invention.

FIG. 3 is a block diagram illustrating a wireless sensor system configured in accordance with one embodiment of the present invention.

### DETAILED DESCRIPTION

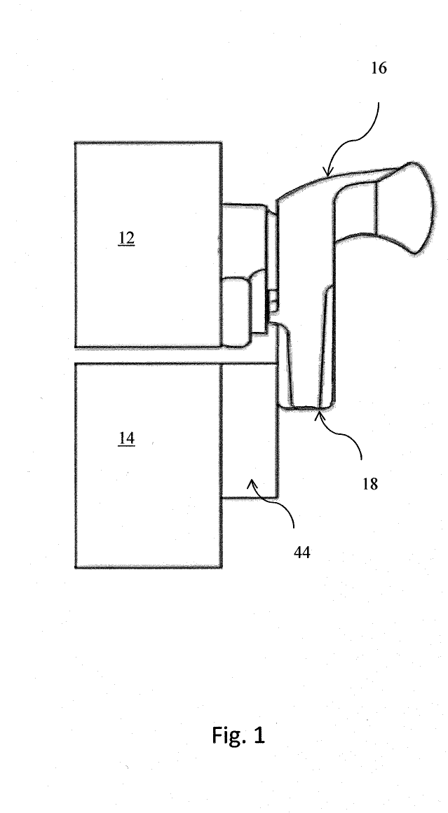

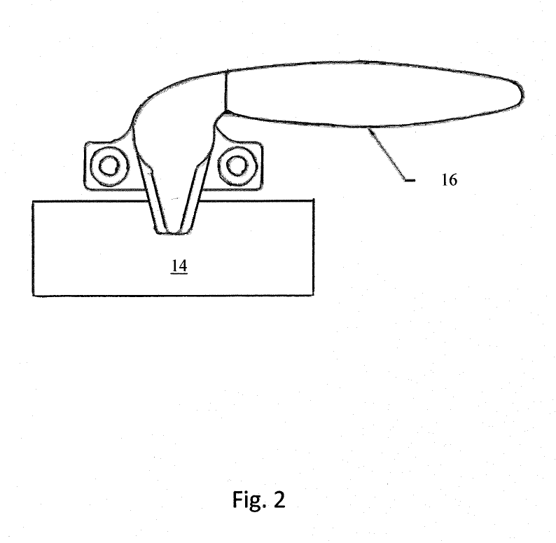

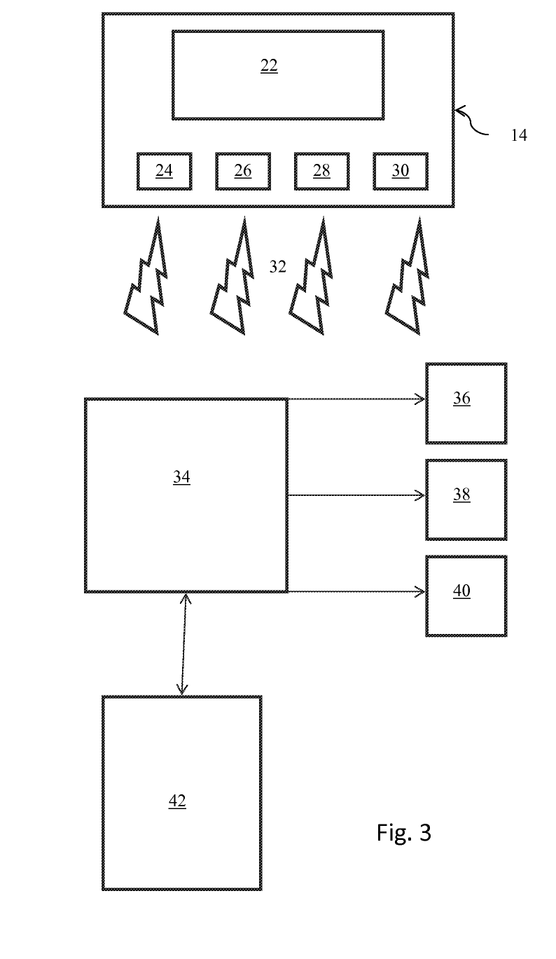

In one embodiment of the present invention, illustrated in FIG. 3, a system is provided for the monitoring of a plurality of windows and doors to provide real time information as to the status of the window, and relay that information to a central processor, enabling the central processor to provide information as to the temperature, humidity, light, and weather seal compression and locked position of windows and doors. As illustrated in FIGS. 1 and 2, a latch 16, fastened on a window or door 12, is configured with a tongue or latch 18 that extends over a plate 44 affixed to a window frame 14. Disposed within the frame 14 and plate 44 are a plurality of sensors 24, 26, 28, 30, illustrated in FIG. 3. One skilled in the art will appreciate that the system as described could be adapted for implementation into other hardware configurations. For example, fastening latches, locks, handles, sweeps, strikes and keepers used on project in, project out, casement, double hung, and slider windows will include the analogous sensor array, with placement of the sensor being determined by the direction the force applied or measured.

FIG. 1 and 2 illustrate window fastening devices used in commercial, municipal, hospital or high rise buildings which consist of a hand operated device 16, 18 which pivots out of the way to open a window. When the window 12 is closed, the hand operated device pivots to a stop position, which allows the underside 18 of the handle cam 16 to engage with a strike or keeper 44 on the frame of the window 14. The force applied by the handle cam 16 to the strike or keeper 44 on the frame draws the window 12 tight to the frame 14. When the window 12 is drawn tight to the frame 14, a weather seal compresses making the window resist air and water infiltration. Such an embodiment will continuously measure temperature, humidity, light, and weather seal compression (force) at the windows. These measurements will be transmitted by wireless communication to a computing device that will evaluate the data and provide a request for corrective action from an appropriate building control system.

In one embodiment of the present invention, radio frequency devices are disposed in the window and door hardware. These devices include Radio Frequency Identification (RFID) tags equipped with sensors 24, 26, 28, 30 disposed within the hardware. The RF device is configured with a data recorder, transponder, and antenna. Data transmitted by the transponder, via the antenna on a wireless signal 32, is received by a central processor 34. The central processor 34 may be a computer or other computing device that is either commercially available hardware provided with suitable software or is custom configured hardware for the monitoring of the desired parameters. The central processor 34 may be configured with a user interface 42, and control modules controlling lighting 36, heating/ventilation/air conditioning 38, and access control/security 40. These control modules 36, 38, 40 may physically control the various functions related to them for a room, building, or campus, such as HVAC 36, lighting 38, and window sash or skylight position 40.

In one embodiment, sensors 24, 26, 28 may be configured to monitor force 24, temperature 26, and humidity 28. In such an embodiment, these sensors may be disposed in the cast metal hardware 14 proximate to the window glass. Photovoltaic cells 22 or other suitable power source may be provided to allow for the recharging power storage for the sensors 24, 26, 28, 30. Photovoltaic devices 30 may, in some embodiments, likewise be used to detect the intensity of light in a particular room by measurement of the voltage of the electricity produced by the cell.

In one such embodiment, a piezo electric force sensor 24 or contact switch sensor is coupled to a Radio Frequency transmitter and is disposed proximately to the hasp of the latch. The pressure applied to the sensor is monitored by a processor, with differences in pressure indicating the opening or closing of the window or door.

In such an embodiment, the sensor data collected by the processor may be used to control energy consumption and HVAC requirements for a building in which the system is disposed. Such monitoring can alert the user to windows and doors requiring replacement or repair, and to compensate for areas of thermal loss without overheating or cooling other areas of the building.

Strength of daylight entering a room via a window configured according to such an embodiment of the present invention may be monitored by a sensor 30 disposed in the window hardware. The level of light thus introduced into a room may therefore be reported to the central processor. In one embodiment of the present invention, the central processor may adjust artificial light in a room thus monitored to maintain adequate light levels while economizing on electricity used.

Temperature sensors 26 disposed in window hardware may also provide data relating to monitor the temperature of the room and in some embodiments the external temperature

The location of window hardware configured according to various embodiments of the present invention, when mounted in any building, is important due to its proximity at the building framed openings where energy losses commonly occur. Most energy consumed in buildings is a result of internal responses to outdoor environmental conditions. A system such as that claimed, will measure the thermal performance of each window in a building and identify those that should be repaired, replaced, or compensated for by the HVAC system.

Daylight entering a room from a window is measured by one embodiment of the present invention in lux, a derived unit of illumination. Such a system identifies levels of light with which average human vision is best supported. If sunlight enters all windows of a room with adequate illumination, the light measurement sensors on the window hardware will report this condition to the substation computer. The substation computer will monitor the condition and if it is constant, a signal will be sent to the electrical system to shut off or dim the lights nearest to the window. When lighting conditions change and less illumination is measured and reported to the substation computer, the substation will monitor the condition and if it is constant, the electrical system will be notified to turn the lights nearest the window on.

The temperature sensors 26 embedded in the hardware configured according to one embodiment of the present invention measure the temperature inside the room at the window fastening point. The temperature measurements are transmitted by RFID to a substation computer. The substation computer compares the average temperature of the room at the windows to the temperature reported at the HVAC control thermostat. The HVAC or solar shading system adjusts to provide uniform heat or cooling to the entire space between the temperature measuring points. This ability to compare temperatures and seek a mechanical response from the HVAC or other system to equalize the room temperature avoids under or over air-conditioned rooms in the summer and over or under heated rooms in the winter. A humidity sensor mounted in the window hardware may be provided to report the presence of humidity to the substation computer. The substation computer monitors and reports consistently above average humidity at affected windows to the building maintenance system so that repairs to glass or replacement of weather sealing can be done to eliminate moisture and subsequent mildew problems.

The RFID window and door hardware configured according to the various embodiments of the present invention allow retrofitting old windows with the hardware for real time energy performance evaluation. As data from the window is analyzed, recommendations for maintenance or replacement of windows to improve energy conservation are made.

The foregoing description of the embodiments of the invention has been presented for the purposes of illustration and description. It is not intended to be exhaustive or to limit the invention to the precise form disclosed. Many modifications and variations are possible in light of this disclosure. It is intended that the scope of the invention be limited not by this detailed description, but rather by the claims appended hereto.

What is claimed is:

1. A system for the sensing of ambient parameters within an enclosure, the system comprising:
A hardware closure whereby an aperture to said enclosure is secured;
At least one sensor disposed within said hardware closure;
A wireless transmitter disposed within said hardware, communicating with said at least one sensor;
A base station, wirelessly in communication with said transmitter;
A processing unit, whereby data collected by said sensor and transmitted by said transmitter to said base station is processed and information relevant to the environment of the enclosure obtained.

2. The system of claim 1 wherein said information relevant to the environment of said enclosure is related to a user.

3. The system according to claim 1 wherein said information relevant to the environment of said enclosure is relayed to an environmental control system.

4. The system according to claim 3 wherein said environmental control system is selected from the group of environmental control systems consisting of lighting controls, heating controls, air conditioning controls, security systems, humidity control systems and combinations thereof.

5. The system according to claim 1 wherein said sensor is a pressure sensor disposed between first and second parts of said hardware closure, such that when said hardware closure is latched, said pressure sensor is compressed.

6. The system according to claim 1 wherein said sensor is a photosensor, whereby light intensity entering said aperture is measured.

7. The system according to claim 1 wherein said sensor is a thermal sensor, whereby ambient temperature is measured.

8. The system according to claim 1 wherein said sensor is a thermal sensor, whereby external temperature is measured.

9. The system according to claim 1 wherein said processing unit is a central processor receiving data from a plurality of enclosures.

10. The, system according to claim 1 wherein said enclosure is a room.

11. The system according to claim 1 wherein said aperture is a window.

12. The system according to claim 1 wherein said aperture is a door.

13. The system according to claim 1 further comprising a photorechargable power storage device supplying power to said sensor and said transmitter.

14. A method for monitoring conditions of a room, said method comprising:
Installing sensors in window and door hardware disposed within a room;
Coupling said sensors to wireless transmitters disposed proximately to said window and door hardware;
Linking wirelessly said wireless transmitters to a base station;
Processing data collected by said sensors with a processor receiving said data collected by said sensors.

15. The method according to claim 13, further comprising adjusting environmental controls based on results from said processing.

16. The method according to claim 14 wherein said environmental controls comprise of heating/cooling systems.

17. The method according to claim 14 wherein said environmental controls comprise lighting systems.

18. The method according to claim 14 wherein said environment controls comprise premises security systems.
